(19) United States
(12) Patent Application Publication
(10) Pub. No.: US 2019/0190341 A1
(43) Pub. Date: Jun. 20, 2019

(54) Electrical Insulation System Based on Epoxy Resins for Generators and Motors

(71) Applicants: Huntsman Advanced Materials Licensing (Switzerland) GmbH, The Woodlands, TX (US); ISOVOLTA AG, Wiener Neudorf (AT)

(72) Inventors: Christian Beisele, Müllheim (DE); Daniel Baer, Riehen (CH); Harald Stecher, Skoerping (DK)

(73) Assignees: Huntsman Advanced Materials Licensing (Switzerland) GmbH, The Woodlands, TX (US); ISOVOLTA AG, Wiener Neudorf (AT)

(21) Appl. No.: 16/311,472

(22) PCT Filed: May 31, 2017
(86) PCT No.: PCT/EP2017/063095

§ 371 Date: Dec. 19, 2018

(30) Foreign Application Priority Data
Jun. 28, 2016 (EP) 16176657.1

(51) Int. Cl. H02K 3/30; H02K 15/10; H02K 15/12; H01B 3/04; B32B 19/06; B32B 5/02; B32B 7/12; B29C 70/48; C08J 5/24; C08G 59/02; C08G 59/68

(52) U.S. Cl. CPC H02K 3/30; B29K 2063/00; H02K 15/12; H01B 3/04; B32B 19/06; B32B 5/02; B32B 7/12; B29C 70/48; C08J 5/24; C08G 59/022; C08G 59/687; B32B 2255/02; B32B 2255/26; B32B 2307/206; B32B 2457/00; B32B 2262/101; B32B 2264/102; B32B 2307/54; H02K 15/105

(57) ABSTRACT

Disclosed is an anhydride-free insulation system for current-carrying construction parts of an electric engine which comprises:

(A) a mica paper or mica tape for wrapping parts of said electric engine that are potentially current-carrying during operation of the engine, which mica paper or mica tape is impregnable via vacuum pressure impregnation with a thermally curable epoxy resin formulation and comprises one or more thermally activatable sulfonium salt initiators for the homopolymerisation of the epoxy resins present in said said thermally curable epoxy resin formulation or a mixture thereof in an amount sufficient to homopolymerize the epoxy resin taken up by the mica paper or mica tape and the construction part of the engine during the vacuum pressure impregnation step;
(B) a thermally curable bath formulation for the vacuum pressure impregnation comprising
(i) a polyglycidyl ether or a mixture thereof, and
(ii) a cycloaliphatic epoxy resin comprising at least two epoxy groups, which are fused to a cycloaliphatic ring, or a mixture thereof,
   which formulation is substantially or, preferably, entirely free of thermally activatable curing initiators for the epoxy resin formulation.

The present invention relates to a novel electrical insulation system for vacuum pressure impregnation of electrical machines, in particular large electrical machines, which insulation system is based on a thermally curable epoxy resin. The invention further relates to a specific mica paper or mica tape for use with said insulation system and to the use of said insulation system in the manufacture of rotors or stators of electrical generators or motors.

Electrical engines, such as generators used for power plants or large electrical motors, contain current-carrying parts, e.g. wires and/or coils, that need to be electrically insulated against each other and/or against other electroconductive parts of the engine with which they would otherwise have direct contact. In medium or high voltage engines this insulation is typically provided by mica paper or mica tapes. After wrapping its current-carrying parts with the mica paper or mica tape, either the whole equipment or only a part thereof is impregnated with a curable, frequently epoxy-based, liquid resin formulation which also penetrates the mica paper or mica tape. This impregnation can advantageously be carried out using the so-called vacuum pressure impregnation (VPI) process. To this purpose the construction components of the engine, which shall be impregnated, are inserted into a container, which is then evacuated, so that humidity and air are removed from the gaps and voids of the components in the container including the gaps and voids in the mica paper or mica tape. Then an impregnation formulation is fed into the evacuated container followed by a period of applying an overpressure e.g. of dry air or nitrogen to the container containing the components, optionally under cautious heating in order to reduce the viscosity of the impregnation formulation sufficiently to allow an appropriate impregnation within a reasonable time, and said formulation penetrates the mica paper or tapes and the gaps and voids existing in the components forced by the pressure difference between the vacuum and the high pressure applied to the components. The residual impregnation formulation is thereafter removed from the container to a storage tank, optionally replenished with new formulation and stored, frequently under cooling, for its next use. The impregnated components are also removed from the container and thermally cured in order to mechanically fix the mica-wrapped current-carrying parts of the component to each other and/or to embed these parts or the entire component into an electrically insulating polymer mass. This cycle of impregnation of components and interim storage of the impregnation formulation until further use is normally repeated until the viscosity of the impregnation formulation increases to an extent that it can no longer penetrate the voids of the components sufficiently within a reasonable time for ensuring an appropriate electrical insulation after cure of the formulation.

There are several important aspects regarding the suitability of a material for a successful industrial vacuum pressure impregnation, particularly of large electrical engines or components thereof.

The viscosity of the impregnation formulation determines to a major extent the impregnation effectiveness and capability of the formulations. The lower the viscosity of the formulation the better and faster it can fill up gaps and voids in the impregnated component and in the mica paper or mica tape.

Furthermore, the afore-mentioned initial viscosity of the formulation, i.e. the viscosity of the formulation, when it is used for the first time, should increase only very slowly over time at the temperatures applied for the impregnation with the formulation and the storage of the formulation between subsequent uses, so that the formulation maintains a reasonable impregnation effectiveness and capability and must not be replaced with new formulation for a reasonably long time period, and this preferably without need to cool the formulation when it is not in use.

Contrary to this, the reactivity of the impregnation formulation should preferably be high at higher temperatures in order to ensure a fast curing of the formulation after impregnation.

The working hygiene, meaning the release of potentially harmful compounds to the working environment, is a further important aspect concerning the handling of an impregnation formulation.

The long-term thermal stability of the cured impregnation formulation, its electrical properties and its mechanical properties must furthermore be good to ensure a long endurance and life-time of the impregnated components of the engines.

A particularly important descriptor of electrical insulation systems based on polymers is the “thermal class” of the system or its cured polymer formulation, which classifies the system or its cured polymer formulation according to the maximum continuous working temperature applicable to the insulation system established for 20 years of working life. Two particularly important thermal classes for medium sized and large electrical engines like motors or generators are “Class F” and “Class H” and permit a maximum attainable continuous use temperature of the cured insulation material of 155° C. and 180° C., respectively.

Another particularly important parameter of a cured electric insulation material is its dielectric dissipation factor tan δ, which is a parameter quantifying the electric energy inherently lost to the insulation material, usually in form of heat, in an alternating electrical field. It corresponds to the ratio of the electric power lost in the insulating material to the electric power applied and is therefore frequently expressed as a percentage, for example a tan δ of 0.1 corresponds to 10% according to this notation. Low dissipation factors are generally desirable in order to reduce the heating-up of the insulator material during operation and thus reduce its thermal decomposition and destruction. The dissipation factor is not only dependent on the chemical composition of the insulating material but also depends on several processing parameters, such as the degree of cure of the insulating material, its content of voids, moisture and impurities etc., and is thus a useful indicator of the actual condition of an electrical insulation. The dissipation factor of polymeric material for a given frequency increases with the temperature of the material. For ensuring a suitable insulation and preventing damage of the engines, it should generally be less than about 10%, even at the maximum permissible working temperature according to the thermaln class of the material.

Due to their generally good over-all properties and characteristics, epoxy resin formulations are frequently used for the preparation of high quality insulation systems for electrical engineering.

The currently most widely used epoxy resin formulation for vacuum pressure impregnation insulation of electrical components is based on diglycidyl ethers of bisphenol A and methylhexahydrophthalic acid anhydride (MHHPA) as curing agent (hardener) and an appropriate curing catalyst (curing accelerator) such as e.g. zinc naphthenate. Insulations based on these formulations are normally rated to be Class H-insulations. In addition, these formulations possess quite a low initial viscosity and thus provide a very good impregnation effectiveness. Furthermore, at least when the curing catalyst is incorporated into the mica paper or mica tape (in an amount to ensure that sufficient curing catalyst is released during the impregnation step to that part of the formulation taken up by the component to be impregnated for allowing its efficient thermal cure after removal of the component from the residual formulation bath), the increase in viscosity of such an impregnation bath over time can be kept within reasonable limits, because no or only marginal residual amounts of curing catalyst are present in the bath formulation before it comes into contact with the mica-wrapped construction parts. Therefore, impregnation baths based on these formulations generally have a good shelf life. Nevertheless, it is recommendable to cool these formulations when they are not in use.

Due to the developing regulatory framework for chemicals however, it is expected that the use of anhydride hardeners in epoxy resin formulations will be restricted in the near future, because of their R42 label as a respiratory sensitizer. Therefore, some anhydrides are already on the SVHC candidate list (substances of very high concern) of the REACH regulation. As all known anhydrides are R42-labeled and even yet unknown anhydrides are expected by toxicologists to become also R42-labeled, it is likely that in some years impregnation formulations based on epoxy resins and anhydride hardeners like those mentioned above may no longer be used without special authorisation.

Epoxy resin based formulations for vacuum pressure insulation which are free of anhydride hardeners are already known. For example, one component epoxy resin compositions based on bisphenol A diglycidyl ethers or bisphenol F diglycidyl ethers or mixtures thereof and a latent curing catalyst for homopolymerisation are on the marketplace, such as e.g.

ARALDITE® XD 4410. Impregnation formulations like these have the additional advantage that the end user need not possess a mixing equipment on site for mixing the epoxy resin with the anhydride hardener, but on the other hand have the disadvantage that the impregnation bath has a rather high initial viscosity because the anhydride component of anhydride-based insulation formulations, which normally is significantly lower in viscosity and thus reduces the overall viscosity of anhydride-containing formulations, is absent in these systems. Formulations of this kind therefore normally must be warmed-up to temperatures around 60° C. in order to achieve a sufficient impregnation effectiveness. Consequently, the increase of viscosity of these fomulations during non-use is also comparably high.

US 2005/0189834 A1 discloses improved anhydride-free one component epoxy resin compositions for vacuum pressure impregnation based on epoxy resins which are liquid at room temperature, in particular based on corresponding bisphenol A, F or A/F or resorcinol diglycidyl ethers or mixtures of such diglycidyl ethers, a latent thermally activatable sulfonium salt initiator such as Sunaid® SI-100 (L), -150 (L) or -160 (L) and a reactive diluent, such as aliphatic or aromatic diglycidyl ethers, styrene oxide or γ-butyrolactone. These compositions exhibit a relatively low viscosity paired with a glass transition temperature T_{g} of about 140-146° C. due to the use of the said amount of reactive diluent and furthermore, an acceptable pot-life at room temperature paired with a sufficently short gelation time at curing temperatures. On the other hand, said compositions are disclosed to permit substantially no addition of inorganic fillers because of the mentioned for viscosity and T_{g} reasons limited possible portion of reactive diluents, which fillers would however be highly desired for improving in particular the thermal conductivity of the cured insulation material so to increase the heat removal from the insulation material to improve its thermal longtime resistance. Accordingly, these systems are of thermal class F maximum, which is no longer considered to be adequate for many engines.

So, there is still a need for improved anhydride-free epoxy resin insulation systems suitable in particular for vacuum pressure impregnation. It is therefore the objective of the present invention to provide such an insulation system having processing characteristics comparable to those of the above described current “gold standard”-systems for vacuum pressure impregnation based on liquid epoxy resins and anhydride hardeners, or even better properties, in particular in respect of impregnation effectiveness, storage stability, curing speed, achievable thermal conductivity and thermal class and the long-term thermal, mechanical and electrical properties including in particular a sufficiently low dielectric dissipation factor at all working temperatures permissible for Class F and Class H insulation systems.

It has now been found that the afore-mentioned objective is solved by an anhydride-free insulation system for current-carrying construction parts of an electric engine, for example in form of a corresponding kit of parts, which comprises:

(A) a mica paper or mica tape for wrapping parts of said electric engine that are potentially current-carrying during operation of the engine, which mica paper or mica tape is impregnable via vacuum pressure impregnation with a thermally curable epoxy resin formulation and comprises a thermally activatable sulfonium salt initiator for the homopolymerisation of the epoxy resins present in said said thermally curable epoxy resin formulation or a mixture thereof in an amount sufficient to homopolymerize the epoxy resin taken up by the mica paper or mica tape and the construction part of the engine during the vacuum pressure impregnation step;
(B) a thermally curable bath formulation for the vacuum pressure impregnation comprising
(i) a polyglycidyl ether or a mixture thereof, and
(ii) a cycloaliphatic epoxy resin comprising at least two epoxy groups, which are fused to a cycloaliphatic ring, or a mixture thereof,
   which formulation is substantially or, preferably, entirely free of thermally activatable curing initiators for the epoxy resin formulation.

The amount of curing initator in the epoxy resin formulation taken up by the mica paper or mica tape and the construction part of the engine during the vacuum pressure impregnation step depends on the nature of the epoxy resin bath formulation to be cured and the desired polymerisation conditions. Suitable amounts can be determined by a skilled person with a few pilot tests. Preferably said amount is between about 0.01 to about 15 weight percent, preferably between 0.05 to about 10 weight percent, more preferably between about 0.1 and about 5 weight percent, based on the epoxy resin, e.g. about 1 to about 3 weight percent.

Mica paper and mica tapes are well known in the art.

For the purposes of this invention the term mica paper is used in its usual sense to refer to a sheet-like aggregate of mica particles, in particular muscovite or phlogopite particles, which are optionally heated to a temperature of about 550 to about 850° C. for a certain time period (e.g. about 5 minutes to 1 hour) to partially dehydrate them and are ground into fine particles in an aqueous solution and then formed into a mica paper by conventional paper-making techniques. Optionally mica consolidation additives like solid resins including inorganic resins such as e.g. boron phosphates or potassium borates and organic resins such as e.g. epoxy resins, polyester resins, polyols, acrylic resins or silicone resins can be added during the formation of the mica paper in order to improve or modify its properties.

The term mica tape as used in this application refers to a sheet-like composite material consisting of one or more layers of mica paper as described above which is (are) glued to a sheet-like carrier material, usually a non-metallic inorganic fabric such as glass or alumina fabric or polymer film such as polyethylene terephthalate or polyimide, using a small amount (about 1 to about 10 g/m² of mica paper) of a resin, preferably an epoxy or acrylic resin or a mixture thereof. The agglutination of the mica paper and the fabric is advantageously performed in a press or a calendar at a temperature above the melting point of the adhesive resin.

The mica paper or the mica tape is then impregnated with a solution comprising the thermally activatable sulfonium salt initiator for the homopolymerisation of the epoxy resins present in said thermally curable epoxy resin formulation or the mixture thereof in a suitable low-boiling solvent, such as propylene carbonate (PC) or methyl ethyl ketone (MEK), γ-butyrolactone and the like or mixtures thereof.

Mica papers and mica tapes impregnated with thermally activatable sulfonium salt initiators for the homopolymerisation of epoxy resins are still novel and are therefore a further subject of the present invention.

For the preparation of mica papers or mica tapes according to the invention the thermally activatable sulfonium salt initiator for the homopolymerisation of epoxy resins or a mixture of such initiators are e.g. dissolved in a suitable low-boiling solvent, such as propylene carbonate or methyl ethyl ketone and the like. The mica paper or mica tape is contacted with said solution, e.g. by immersion therein or by spraying, and the solvent removed to leave the thermally activatable sulfonium salt initiator(s) on and/or inside the structure of the mica paper or tape. The concentration of sulfonium salt initiator in the impregnation solution is not critical and can, for instance, vary between e.g. about 0.01 and about 10 percent by weight of sulfonium salt initiator. The higher the concentration of initiator, the higher is the final load of the mica paper or mica tape achieved during an impregnation step.

The mica paper or mica tape according to the invention must contain the thermally activatable sulfonium salt initator in an amount sufficient to cure the epoxy resin taken up by the mica paper or mica tape and eventually by the construction part of the engine during the vacuum pressure impregnation. For this purpose, the mica paper or mica tape preferably comprises the thermally activatable sulfonium salt initiator or the mixture thereof in an amount of about 0.01 to about 10 g/m² of the mica paper or mica tape, preferably about 0.02 to about 0.5 g/m², more preferably about 0.04 to about 0.2 g/m².

Thermally activatable sulfonium salt initiators suitable for the present invention are well known in the art and disclosed, for example, in U.S. Pat. Nos. 4,336,363, 5,013,814, 5,296,567, 5,374,697, EP-A-0799682 or EP-A-0914936, the disclosure of which is incorporated herein by reference.

Preferably, the thermally activatable sulfonium salt initiator(s) are selected from the compounds of formula I to IV

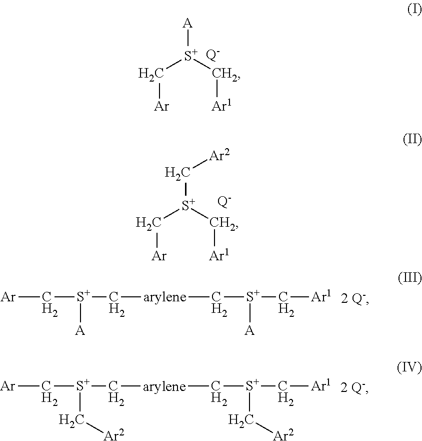

wherein
A is C₁-C₁₂alkyl, C₃-C₈cycloalkyl, C₄-C₁₀cycloalkylalkyl or phenyl, which is unsubstituted or substituted by one or more substituents selected from C₁-C₈alkyl, C₁-C₄alkoxy, halogen, nitro, phenyl, phenoxy, C₁-C₄alkoxycarbonyl or C₁-C₁₂alkanoyl;
Ar, Ar¹ and Ar², independently of one another are phenyl or naphthyl, which is unsubstituted or substituted by one or more substituents selected from C₁-C₈alkyl, C₁-C₄alkoxy, halogen, nitro, phenyl, phenoxy, C₁-C₄alkoxycarbonyl or C₁-C₁₂alkanoyl; and Q⁻ is SbF₆⁻, AsF₆⁻ or SbF₅(OH)⁻.

C₁-C₁₂alkyl as A in formula I or III can be straight-chain or branched. For example A can be methyl, ethyl, n-propyl, isopropyl, n-butyl, sec-butyl, tert-butyl or any pentyl, hexyl, heptyl, octyl, nonyl, decyl, undecyl of dodecyl residue.

Examples of suitable C₃-C₈cycloalkyl residues as A or as part of C₄-C₁₀cycloalkylalkyl as A include e.g. cyclopropyl, cyclopentyl, cyclohexyl, cycloheptyl or cyclooctyl rings.

The alkyl part of C₄-C₁₀cycloalkylalkyl comprises preferably 1 to 4 carbon atoms, more preferably 1 or 2 carbon atoms. Examples of suitable C₄-C₁₀cycloalkylalkyl residues as A are e.g. cyclohexylmethyl, cyclohexylethyl or cyclohexylbutyl. Most preferably the alkyl part of C₄-C₁₀cycloalkylalkyl is methyl.

More preferably, the sulfonium salt initiator is selected from the compounds of formula I or II, wherein

A is C₁-C₆alkyl or phenyl, which is unsubstituted or substituted by halogen or C₁-C₄alkyl; Ar, Ar¹ and Ar² are each phenyl, which, independently of each other, is unsubstituted or substituted by one or more substituents selected from C₁-C₈alkyl, C₁-C₄alkoxy; Cl or Br; and Q⁻ is SbF₆⁻ or SbF₅(OH)⁻.

The most preferred sulfonium salt initiators are tribenzylsulfonium hexafluoroantimonate, dibenzylethylsulfonium hexafluoroantimonate and in particular dibenzylphenylsulfonium hexafluoroantimonate, which are unsubstituted or wherein the phenyl groups (including those of the benzyl groups) are substituted by one or two methyl or chloro substituent, in particular dibenzylphenylsulfonium hexafluoroantimonate (e.g. ZK RT 1507, available from Huntsman).

The epoxy resins contained in component (i) of the thermally curable bath formulation for the vacuum pressure impregnation (B) according to the present invention may in principle be any polyglycidyl ether compound. Illustrative examples of suitable polyglycidyl ether compounds are:

Polyglycidyl ethers which are obtainable by reacting a compound containing at least two free alcoholic hydroxyl groups and/or phenolic hydroxyl groups and epichlorohydrin under alkaline conditions or in the presence of an acid catalyst and subsequent treatment with alkali.

Important representatives of polyglycidyl ethers are derived from phenolic compounds, such as mononuclear phenols, typically resorcinol or hydroquinone, or from polynuclear phenols such as bis(4-hydroxyphenyl)methane (bisphenol F), 2,2-bis(4-hydroxyphenyl)propane (bisphenol A), mixtures of bisphenol A and bisphenol F diglycidylether, 2,2-bis(3,5-dibromo-4-hydroxyphenyl)propane, as well as from novolacs obtainable by condensation of aldehydes such as formaldehyde, acetaldehyde, chloral or furfuraldehyde, with phenols such as preferably phenol or cresol, or with phenols which are substituted in the nucleus by chlorine atoms or C₁-C₉alkyl groups, for example 4-chlorophenol, 2-methylphenol or 4-tert-butylphenol, or which are obtainable by condensation with bisphenols of the type cited above.

Suitable diglycidylethers may also be derived from acyclic alcohols, typically from ethylene glycol, diethylene glycol and higher poly(oxyethylene) glycols, 1,2-propanediol or poly(oxypropylene) glycols, 1,3-propanediol, 1,4-butanediol, poly(oxytetramethylene) glycols, 1,5-pentanediol, 1,6-hexanediol, 2,4,6-hexanetriol, glycerol, 1,1,1-trimethylolpropane, pentaerythritol, sorbitol, as well as from polyepichlorohydrins. They may also be derived from cycloaliphatic alcohols such as 1,3- or 1,4-dihydroxycyclohexane, 1,4-cyclohexanedimethanol, bis(4-hydroxycyclohexyl)methane, 2,2-bis(4-hydroxycyclohexyl) propane or 1,1-bis(hydroxymethyl)cyclohex-3-ene, or they contain aromatic nuclei such as N,N-bis(2-hydroxyethyl)aniline or p,p′-bis(2-hydroxy-ethylamino)diphenylmethane.

Particularly preferred polyglycidylethers for use as component (i) of the thermally curable bath formulation for the vacuum pressure impregnation (B) are diglycidyl ethers of phenolic compounds, preferably of bisphenol compounds, in particular diglycidyl ethers of bisphenol A, bisphenol F or mixtures of bisphenol A and bisphenol F having the formula:

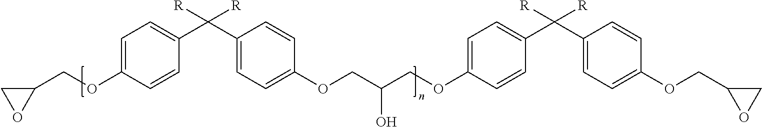

wherein both residues R of one bisphenol unit either represent hydrogen or methyl and n is a number equal or greater than zero, in particular 0 to 0.3, and represents an average over all molecules of the applied resin.

The lower the index n is the lower is the viscosity of these resins. For the purposes of the present invention n is therefore preferably equal to zero or substantially equal to zero, e.g. in the range of 0 to 0.3 corresponding to about 5.85 epoxy equivalents per kg bisphenol A diglycidyl ether resin to about 4.8 epoxy equivalents per kg bisphenol A diglycidyl ether resin and about 6.4 epoxy equivalents per kg bisphenol F diglycidyl ether resin to about 5.3 epoxy equivalents per kg bisphenol A diglycidyl ether resin.

Mostly preferred as epoxy resins for component (i) of the thermally curable bath formulation for the vacuum pressure impregnation (B) are diglycidyl ethers of bisphenol A and/or bisphenol F obtainable by distillation of corresponding raw diglycidyl ethers, wherein n is substantially equal to zero such as bisphenol A diglycidylether resins with about 5.7 to 5.9 epoxy equivalents per kg or bisphenol F diglycidylether resins with about 6.0 to 6.4 epoxy equivalents per kg. The distilled diglycidylethers furthermore comprise generally a reduced quantity of other side products and/or impurities and have therefore normally an improved shelflife.

Cycloaliphatic epoxy resins suitable as component (ii) of the thermally curable bath for the vacuum pressure impregnation comprise at least two epoxy groups fused to a cycloaliphatic ring in the molecule of the epoxy. Preferred examples include resin like e.g. diepoxides of dicyclohexadiene or dicyclopentadiene, bis(2,3-epoxycyclopentyl) ether, 1,2-bis(2,3-epoxycyclopentyloxy)ethane, 3,4-epoxycyclohexyl-3′,4′-epoxycyclohexanecarboxylate and 3,4-epoxycyclohexylmethyl-3′,4′-epoxycyclohexanecarboxylate.

3,4-epoxycyclohexylmethyl-3′,4′-epoxycyclohexanecarboxylate, which is e.g. commercially available as ARALDITE® CY 179-1 from Huntsman, Switzerland, is particularly preferred as epoxy resin for component (ii) thermally curable bath according to the present invention.

The thermally curable bath formulation according to the invention preferably comprises component (i) and component (ii) in a weight ratio between about 5:1 and about 1:10, more preferably between about 1:1 and about 1:6, most preferably between about 1:2 and about 1:6, e.g. about 1:5.6.

The viscosity of the epoxy resin bath formulation according to the invention does preferably viscosity not exceed about 75 mPa·s at 60° C., more preferably not exceed about 50 mPa·s at 60° C.

The epoxy resins of the thermally curable epoxy bath according to the present invention provide, on one hand, a very low viscosity at room temperature or moderately elevated temperatures of about 20° C. to about 60° C. and result, on the other hand, when thermally cured with a curing initiator/co-initiator system according to the present invention, in a cured insulation material of insulation class F or H, i.e. permit a maximum continuous use temperature of 155° C. and 180° C., respectively, which insulation material furthermore exhibits excellent dielectric dissipation factors (tan δ) being significantly below 10% at 155° C.

The thermally curable bath formulation for vacuum pressure impregnation (B) according to the invention may optionally comprise (iii) additives for improving the properties of the thermally curable epoxy bath formulation and/or the cured insulation material derived therefrom, such as tougheners or aids for improving the thermal conductivity of the cured insulation material such as micro and/or nano particles selected from the group consisting of metal or semi-metal oxides, carbides or nitrides and wetting agents therefore, as long as these agents are used in amounts that do not have a negative impact on the properties of the epoxy bath formulation before cure, like e.g. on its shelflife or viscosity, and/or on essential properties of the finally obtained cured insulation material, in particular on its dielectric dissipation factor and on its thermal classification.

Suitable tougheners for the purposes of the present invention include e.g. reactive liquid rubbers such as liquid amine- or carboxyl-terminated butadiene acrylonitrile rubbers, dispersions of core-shell rubbers in low viscosity epoxy resins as commercially available e.g. under the tradename Kane Ace™ MX or GENIOPERL® (supplied by Wacker).

Suitable metal or semi-metal oxides, carbides or nitrides include e.g. aluminum oxide (Al₂O₃), titanium dioxide (TiO₂), zinc oxide (ZnO), cerium oxide (CeO₂), silica (SiO₂), boron carbide (B₄C), silicon carbide (SiC), aluminium nitride (AlN) and boron nitride (BN) including cubic boron nitride (c-BN) and particularly hexagonal boron nitride (h-BN), which may optionally be surface-modified in a known way, e.g. by treatment with γ-glycidyloxypropyltrimethoxysilane, to improve the interface and adhesion between the filler and the epoxy matrix. Mixtures of metal, semi-metal oxides, carbides and/or nitrides can of course also be used.

Particularly preferred are metal and semi-metal nitrides, in particular aluminium nitride (AlN) and boron nitride (BN), in particular hexagonal boron nitride (h-BN).

Micro particles are understood for the purposes of this application to include particles of an average particle size of about 1 μm or more, provided that the filler particles can still penetrate the mica tape and the gaps and voids of the construction part to be impregnated. Preferably the micro particles have a so-called volume diameter D(v)50 of up to about 10 μm, more preferably from about 0.1 to about 5 μm, in particular about 0.1 to about 3 μm, e.g. about 0.5 to 1 μm, wherein a volume diameter D(v)50 of x μm specifies a filler sample wherein 50% of the volume of its particles have a particle size of equal or less than x μm and 50% a particle size of more than x μm. D(v)50 values can e.g. be determined by Laserdiffractometry.

Micro particles, in particular when present for improvement of the thermal conductivity of the insulation material, are preferably added in amounts of 2 to about 60% by weight based on the total weight of the thermally curable epoxy resin formulation according to the invention, more preferably in amounts of about 5 to about 40% by weight, in particular about 5 to about 20% by weight.

Nano particles are understood for the purposes of this application to include particles of an average particle size of about 100 nm or less. Preferably the nano particles have a volume diameter D(v)50 of up to about 10 to about 75 nm, more preferably from about 10 to about 50 nm, in particular about 15 to about 25 nm, e.g. about 20 nm.

Nano particles are typically used in smaller quantities than micro particles, because in larger amounts they sometimes tend to raise the bath viscosity more than a similar amount of microparticles. Suitable amounts of nano particles preferably range from about 1 up to about 40% by weight based on the total weight of the thermally curable epoxy resin formulation according to the invention, more preferably from about 5 to about 20% by weight, in particular from about 5 to about 15% by weight.

Micro and nano particles can also be used together in admixture.

Preferably, micro and nano particles are surface modified to make them more compatible with the epoxy resins, e.g. surface-treated with γ-glycidyloxypropyltrimethoxysilane, or are used in combination with a wetting agent for said purpose.

In a particularly preferred embodiment of the insulation systems according to the invention the thermally curable epoxy bath formulation (B) comprises micro particles, nano particles or a mixture thereof, preferably nano particles, which particles are selected from metal or semi-metal oxides, carbides or nitrides, in particular from metal or semi-metal carbides or nitrides and, optionally, a wetting agent, in particular one of formula:

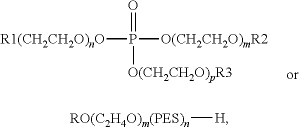

as described above.

The insulation systems according to the invention are particularly suitable for use in the manufacture of rotors or stators of electrical generators or motors, in particular of large generators or motors. This use is therefore another subject of the invention.

The electrical insulation systems according to the invention can e.g. be used in the manufacture of rotors or stators of electrical generators or motors according to a process, wherein

(a) the potentially current-carrying parts of the rotor or stator or the construction part thereof are wrapped with a/the mica paper or mica tape which is impregnable via vacuum pressure impregnation with a thermally curable epoxy resin formulation and comprises one or more thermally activatable sulfonium salt initiators, which is contained by said mica paper or mica tape in an amount sufficient to cure the epoxy resin taken up by the mica paper or mica tape and the construction part of the engine during a vacuum pressure impregnation step,
(b) the rotor or stator or the construction part thereof is inserted into a container,
(c) the container is evacuated,
(d) a thermally curable bath formulation for the vacuum pressure impregnation comprising (i) a polyglycidyl ether or a mixture thereof and (ii) cycloaliphatic epoxy resin comprising at least two epoxy groups, which are fused to a cycloaliphatic ring, or a mixture thereof, which bath formulation is substantially or, preferably, entirely free of thermally activatable curing initiators for the epoxy resin formulation, is fed into the evacuated container followed by a period of applying an overpressure e.g. of dry air or nitrogen to the container containing the rotor or stator or the construction part thereof, optionally under cautious heating in order to reduce the viscosity of the thermally curable bath formulation in the container sufficiently to allow that said formulation penetrates said mica paper or mica tape and the gaps and voids existing in the structure of the rotor or stator or the construction part thereof within a desired time period forced by the pressure difference between the vacuum and the high pressure applied to the components,
(e) the residual thermally curable bath formulation is removed from the container, and
(f) the rotor or stator or the construction part thereof, impregnated with the thermally curable bath formulation, is removed from the container and heated after removal from the container in order to cure the thermally curable bath formulation comprised by said rotor or stator or the construction part thereof.

A corresponding process for using an anhydride-free insulation system according to the invention is a further subject of the invention.

The length of the period of applying the overpressure to the container can be chosen by a skilled person depending e.g. on the viscosity of the thermally curable bath formulation, the structure and impregnability of the mica paper or mica band used, the size of the rotor or stator or the construction part thereof, which shall be impregnated, and the complexity of their construction and ranges preferably between about 1 and about 6 hours.

For performing the cure of the thermally curable bath formulation comprised by the rotor or stator or the construction part thereof, they are heated. The curing temperature depends on the epoxy resin formulation applied and the specific sulfonium salt initiator(s) applied and ranges generally from about 60 to about 200° C., preferably from about 80 to about 160° C.

In an especially preferred embodiment of the above process for using the insulation systems according to the invention in the manufacture of rotors, stators or construction parts thereof the thermally curable bath formulation is fed into the evacuated container from a storage tank and is returned to said storage tank again after removal from the container and is stored in the tank, optionally under cooling, for further use. Before further use the used bath formulation can be replenished with new formulation.

In a further aspect the present invention relates to mica papers or the mica tapes for use with insulation system described above, which are impregnable via vacuum pressure impregnation with a thermally curable epoxy resin formulation and comprise one or more thermally activatable sulfonium salt initiators for the homopolymerisation of epoxy resins.

Preferably, said mica papers or mica tapes comprise the one or more thermally activatable sulfonium salt initiators in an amount of about 0.01 to about 10 g/m² of the mica paper or mica tape, preferably about 0.02 to about 5.0 g/m², more preferably about 0.04 to about 2.0 g/m².

Preferred embodiments of the mica papers or mica tapes according to the invention include mica papers or mica tapes comprising dibenzyl-phenyl-sulfonium hexafluoro-antimonate as the thermally activatable curing initiator.

### EXAMPLES

The following Examples serve to illustrate the invention. Unless otherwise indicated, the temperatures are given in degrees Celsius, parts are parts by weight and percentages relate to percent by weight (weight percent). Parts by weight relate to parts by volume in a ratio of kilograms to litres.

(A) Description of inqredients used in the Examples:
CY 179-1: bis-(epoxycyclohexyl)-methylcarboxylate, supplier: Huntsman, Switzerland;
MY 790-1 CH: distilled bisphenol A diglycidyl ether (BADGE), epoxy eq.: 5.7-5.9 eq./kg, supplier: Huntsman, Switzerland;
PY 306 bisphenol F diglycidyl ether (BFDGE), epoxy eq.: 6.0-6.4 eq./kg, supplier: Huntsman, Switzerland;
HY 1102: methylhexahydrophthalic acid anydride (MHHPA), supplier: Huntsman, Switzerland;
XD 4410: one-component epoxy-based VPI-resin based on BADGE, Bisphenol F diglycidyl ether (BFDGE) and 2,3-epoxypropyl-o-tolylether, supplier Huntsman, Switzerland;
DY 9577: curing accelerator for epoxy anydride hardener systems based on borontrichloride-octyldimethylamine adduct (1:1), supplier: Huntsman, Switzerland;
DY 073-1: curing accelerator for epoxy anydride hardener systems based on a tertiary amine;
ZK RT 1507: Dibenzyl-phenyl-sulfonium-SbF6, supplier: Huntsman, Switzerland;
PC Propylene-carbonate: supplier: Huntsman

Mica tapes are composed of mica paper, optionally containing one or more additives or resins for consolidation of the mica paper, and a light-weight glass fabric made from E-glass or a polymer film that is adhered to the mica paper with a non-reactive or reactive adhesive for mechanical support. Following tapes were used in the Examples:

New inventive mica tape containing ZK RT 1507, supplier: Isovolta, Austria; Poroband ME 4020: mica tape containing zinc naphthenate, supplier: Isovolta, Austria; Poroband 0410: mica tape without accelerator, supplier: Isovolta, Austria.

(B) Comparison of Properties of Comparative and Inventive Formulations without Tape:

### a) Comparative Example 1 (MY 790-1 CH/HY 1102/DY 9577/DY 073)

This comparative example is performed in order to compare the properties of the cured neat resins (without mica tape). For curing of the Comparative Example 1, small amounts of the curing accelerators DY 9577 and DY 073-1 are used instead of Zn— naphthenate (contained in typical commercially available-tapes) because Zn-naphthenate is quite difficult to get homogenously dispersed in the epoxy/anhydride mixture.

To test the bath stability at 23° C., 1 kg of MY 790-1 CH and 1 kg of HY 1102 are mixed together in a steel vessel with an anchor stirrer at ambient temperature for 5 minutes. This mixture is then kept in an inert glass bottle for the storage test regarding bath stability at 23° C. for 80 days.

The viscosity of the mixture is determined before and after the storage at a measurement temperature of 60° C. While the initial viscosity at 60° C. is 32 mPas, the viscosity increased during the storage time of 80 days by 12%.

To test all the other properties of the cured material, to 1 kg of the mixture described above as replacement for the Zn— naphthenate that normally would promote the curing of impregnated tape, 0.8 g of DY 9577 and 0.2 g of DY 073-1 are added and mixed for another 10 minutes. This mixture is then cast in to moulds in the corresponding thicknesses to prepare plates for the various tests. After pouring the material to the moulds, these are put into an oven for 16 hours at 90° C. and 10 hours at 140° C.

### b) Comparative Example 2 (XD 4410)

This example relates to a homopolymerisable aromatic epoxy system containing the catalyst in the composition (one-component system). It does normally go along with mica-tapes free of catalyst.

The commercial product Araldite® XD 4410 is directly used to check the storage stability at 23° C. over 409 days. XD 4410 exhibits a viscosity of 78 mPas (initial at 60° C.) and an increase of less than 6% during 409 days.

The reactivity of this mixture is checked with a gel timer at 80° C. and 140° C.

To produce plates for the other tests, it is poured into moulds of corresponding thicknesses to prepare plates for the various tests. After pouring the material into the moulds, these are put to an oven for 4 hours at 125° C. and 12 hours at 170° C.

### c) Inventive Example 1

The inventive example 1 of thermally curable bath formulation (B) for an insulation system according to the invention system is a mixture of 848.5 g resin CY 179-1 and 151.9 g MY 790-1 CH (prepared at ambient temperature).

The stability of this bath formulation is checked during 20 hours storage at 100° C. The initial viscosity is 40.4 mPas and the viscosity after storage 40.2 mPas.

To produce test plates without a mica tape 0.5 g of ZK RT 1507 are dissolved in 99.5 g propylene carbonate.

198 g of the above described thermally curable bath formulation are mixed with 2 g of the mentioned solution of ZK RT 1507 in propylene carbonate.

The reactivity of this mixture is checked with a gel timer at 80° C. and 140° C.

To produce plates for the other tests, the formulation is poured into moulds of corresponding thicknesses to prepare plates for the various tests. After pouring the material into the moulds, these are put into an oven for 30 min at 80° C., 30 min 130° C. and 10 hours at 150° C.

### d) Inventive Example 2

The inventive example 2 of thermally curable bath formulation (B) for an insulation system according to the invention system is a mixture of 495 g resin CY 179-1 and 495 g MY 790-1 CH (prepared at ambient temperature).

The stability of this bath formulation is checked during 20 hoursstorage at 100° C. The initial viscosity is 65.4 mPas and the viscosity after storage 65.4 mPas.

To produce test plates without a mica tape 0.5 g of ZK RT 1507 are dissolved in 99.5 g propylene carbonate (LME11135).

198 g of the above described thermally curable bath formulation are mixed with 2 g of the mentioned solution of ZK RT 1507 in propylene carbonate.

The reactivity of this mixture is checked with a gel timer at 80° C. and 140° C.

To produce plates for the other tests, the formulation is poured into moulds of corresponding thicknesses to prepare plates for the various tests. After pouring the material into the moulds, these are put into an oven for 30 min at 80° C., 30 min 130° C. and 10 hours at 170° C.

### e) Inventive Example 3

The inventive example 3 of thermally curable bath formulation (B) for an insulation system according to the invention system is a mixture of 848.5 g resin CY 179-1 and 151.5 g PY 306 (prepared at ambient temperature).

The stability of this bath formulation is checked during 20 hoursstorage at 100° C. The initial viscosity is 35.6 mPas and the viscosity after storage 35.8 mPas.

To produce test plates without a mica tape 0.5 g of ZK RT 1507 are dissolved in 99.5 g propylene carbonate.

198 g of the above described thermally curable bath formulation are mixed with 2 g of the mentioned solution of ZK RT 1507 in propylene carbonate.

The reactivity of this mixture is checked with a gel timer at 80° C. and 140° C.

To produce plates for the other tests, the formulation is poured into moulds of corresponding thicknesses to prepare plates for the various tests. After pouring the material into the moulds, these are put into an oven for 30 min at 80° C., 30 min 130° C. and 10 hours at 170° C.

### f) Test Results

The results of the afore-mentioned tests with the curable epoxy bath formulations of Comparative Examples 1 and 2 as well as the Inventive Examples 1, 2 and 3 are summarized in Table 1 below (data determined without tape, just for illustrating the properties of the epoxy matrix of such insulation systems).

TABLE 1

| | Comparative | Comparative | Inventive | Inventive | Inventive |
|---|---|---|---|---|---|
| | Example 1 | Example 2 | Example 1 | Example 2 | Example 3 |
| MY 790-1 | 100 | | 15 | 49.5 | |
| HY 1102 | 100 | | | | |
| XD 4410 | | 100 | | | |
| CY 179-1 | | | 84 | 49.5 | 84 |
| PY 306 | | | | | 15 |
| ZK RT 1507, | | | 1 | 1 | 1 |
| 0.5% in PC | | | | | |
| DY 9577 | 0.16 | | | | |
| DY 073-1 | 0.04 | | | | |
| Working | possible | very good | very good | very good | very good |
| hygiene | anhydride | | | | |
| | contact | | | | |
| Viscosity at | 32 | 78 | 40.4* | 65.4* | 35.6* |
| 60° C. [mPa · s] | | | | | |
| Viscosity | 12% | <6% | very good | very good | very good |
| increase of | (80 days)** | (409 days) | | | |
| formulation | | | | | |
| when stored | | | | | |
| at 23° C. | | | | | |
| Viscosity of | 34.2** | n.a. | 40.2* | 65.4* | 35.8* |
| formulation | | | | | |
| at 60° C. after | | | | | |
| 20 h storage | | | | | |
| at 100° C. | | | | | |
| Storage tank | yes | no | no | no | no |
| cooling | | | | | |
| needed | | | | | |
| Number of | 2 | 1 | 1 | 1 | 1 |
| components | | | | | |
| to mix | | | | | |
| Gelation time | n.a. | >>1000′ | 16′ 40″ | 14′ | 21′ 20″ |
| at 80° C. | | | | | |
| Gelation time | n.a. | 30′ | 1′ 30″ | 1′ 30″ | 1′40″ |
| at 140° C. | | | | | |
| Glass | 144° C. | 130° C. | 171° C. | 150° C. | 151° C. |
| transition | | | | | |
| temperature | | | | | |
| T_{g} | | | | | |
| Cure | 16 h(90° C.)/ | 4 h(125° C.)/ | 0.5 h(80° C.)/ | 0.5 h(80° C.)/ | 0.5 h(80° C.)/ |
| conditions | 10 h(140° C.) | 12 h(170° C.) | 0.5 h(130° C.)/ | 0.5 h(130° C.)/ | 0.5 h(130° C.)/ |
| | | | 10 h(150° C.) | 10 h(170° C.) | 10 h(170° C.) |
| Dissipation | 8% | 12% | 1.8% | 4% | 2.5% |
| factor tan | | | | | |
| δ at 155° C. | | | | | |
| 5% weight | 390° C. | 400° C. | 415° C. | 415° C. | 410° C. |
| loss at (TGA | | | | | |
| 20 K/min) | | | | | |
| Tensile | 45 Mpa | ca. 45 Mpa | 34 Mpa | 38 Mpa | 30 Mpa |
| strength | | | | | |
| Elongation at | 1.75% | ca. 2% | 1.1% | 1.2% | 1% |
| break | | | | | |
| Thermal | H | F | H | H | H |
| insulation | | | | | |
| class rating | | | | | |

*without ZK RT 1507
**without DY 9577 and DY 073-1
T_{g} determined according to ISO 6721/94;
Dielectric dissipation factor tan δ determined according to IEC 60250;
5% weight loss at (TGA 20 K/min): The indicated temperature is the temperature, for which the weight loss is just reaching 5% during heating a sample with a heating rate of 20 K/min.
Tensile strength and elongation at break determined at 23° C. according to ISO R527

### (C) Preparation of Mica Paper and Mica Tapes According to the Invention and Application Tests Thereof:

A mica paper sheet based on uncalcined mica flakes with an areal weight of 160 g/m² is cut in a rectangular shape of the size 200×100 mm. For mica paper impregnation a solution of LME 11135 (=0.5 wt % ZK RT 1507 in PC) in methyl ethyl ketone (MEK) is prepared which contains 10.5 wt % of LME11135 (=525 mg ZK RT 1507). The mica sheet is impregnated with 2.0 g of the solution and the solvent is removed in an oven at 85° C. for 1 min. The mica paper thus prepared contains 52.5 mg/m² ZK RT 1507.

The treated mica paper is either used as it is or is combined with a glass fabric. In that case a glass fabric style 792 (23 g/m², 26×15 5.5 tex/5.5 tex), which has previously been coated with 3 g/m² of an epoxy/acrylic resin mixture, is adhered to the mica tape using a solid epoxy resin having a melting point around 100° C. For this purpose the solid epoxy resin is evenly dispersed on the treated mica paper. Then the glass fabric is laid on top. The specimen is put into a heated press to melt the epoxy resin (130° C. for 30 s). The glass fabric and the mica paper stick together after removing from the press.

The obtained mica paper sheets and glass/mica specimens are cut in halfs to give 100×100 mm samples. 4 layers of mica paper are piled with each 1.5 g evenly distributed impregnation resin between the layers giving a total resin weight of 4.5 g.

The impregnated specimens are used for monitoring the dissipation factor tan δ during cure in a Tettex instrument or are cured in a heated press. Cure in the Tettex instrument and tan δ measurement is conducted at 155° C.

Cure in the hot press is conducted following the following temperature cycle: 90° C. at 2 bar for 2 h-130° C. at 2 bar for 2 h-180° C., no pressure for 10 h.

The cured composites are subjected to tan δ measurement at 155° C.

The results of the afore-mentioned tests with the curable epoxy bath formulations of Comparative Example 1 (not containing DY9577 and 073-1) with Poroband ME 4020 (Reference system 1) and Comparative Example 2 with Poroband 0410 (Reference System 2) as well as the Inventive Example 1 are summarized in Table 2 below.

TABLE 2

| | | | Inventive System | | |
|---|---|---|---|---|---|
| | Reference | Reference | Exam- | Exam- | Exam- |
| | System 1 | System 2 | ple 1 | ple 2 | ple 3 |
| Dissipation factor | 4.4% | 22.8% | 3.7% | 6.8% | 2.5% |
| tan δ (at 155° C.) | | | | | |

Dissipation factor tan δ determined according to IEC 60250 in a Tettex instrument using a guard ring electrode at 400 V/50 Hz;

### (D) Conclusions from the Examples Above

a) Conclusions Based on the Comparisons without Tape:

Regarding the first critical aspect of working hygiene, the anhydride-free inventive example is better than the classical anhydride-based reference, because it is does not contain a respiratory sensitizer and therefore is not regarded as a SVHC.

While the anhydride-based reference is quite low viscous, the existing anhydride-free solution according to Comparative Example 2 (XD 4410) is relatively high viscous and hence more difficult to impregnate into the mica-tape and the windings. The inventive bath formulations have a viscosity level quite similar to the anhydride-based reference and can impregnate better than the anhydride-free reference bath formulation based on XD 4410.

Regarding the bath stability, the anhydride-based reference builds up the viscosity at 23° C. during only 80 days already by 12%. To overcome this issue, a cooled storage is normally applied. The anhydride-free reference bath formulation (XD 4410) is quite stable and therefore does not need a cooling. Surprisingly the bath systems according to the invention based on CY 179-1 and aromatic resins are quite stable as there was virtually no change in viscosity even when treating the material for 20 hours at 100° C. Hence also no cooling would be typically required for the inventive bath composition.

A further advantage of the inventive system over the traditional reference is that there is no need for mixing the 2 components when refreshing the bath as it can be applied as one-component product (assuming a pre-mix of CY 179-1 and MY 790-1 CH to be delivered. As there is no anhydride that may partly evaporate during the application process out of the bath and hence impacting the optimal mixing ratio with the reference, this issue does not happen with the inventive example resulting in a better quality consistency.

The reactivity of the inventive product is moderate at temperatures up to 80° C. but very high at temperatures around 140° C. This means that this system is quite latent and therefore stable at storage temperature but highly reactive at higher temperature.

The one component reference according to Comparative Example 2 is also quite slow at 80° C., however it is still slow at high curing temperature (gel time of 30 min at 140° C.).

The T_{g} of the inventive system is slightly higher. That is positive, as there is more distance to the application critical temperature of 155° C.

The most positive and surprising finding is that the dielectric dissipation factor tan δ at 155° C. is even lower and hence better than that of the anhydride-based reference containing a tertiary amine or boron trichloride-octyldimethylamine adduct as curing accelerator.

A dielectric dissipation factor tan δ of >10% at 155° C. is the main issue of the anhydride free reference example (XD 4410) of Comparative Example 2 and the reason why such systems could not be used for class H application, although it would be even better temperature stable according to the weight loss short term experiment given in the table. In this respect the inventive example is at least as stable as the unmodified reference.

So as a conclusion the new inventive insulation system surprisingly eliminates all issues of traditional insulation system for vacuum pressure impregnation, the anhydride/SVHC/REACH issue as well the issues of already known anhydride-free systems such as high viscosity, low reactivity at high temperature, limitation to class F and a too high dielectric dissipation factor tan δ of more than 10%.

### b) Conclusions Based on the Comparisons of Impregnated Mica Paper and Mica Tapes

In comparison to state of the art insulation systems the tan δ values of the inventive system can reach significantly lower values. This can be the basis for a higher workload. Because less energy is lost and converted to heat, the thermal stress on the material shall be lower. Because the viscosity of all inventive resins is low, the impregnability is good also at room temperature.

Also the compatibility with polyester-polyols could be proven which can be used for mechanical enhancement of the impregnated mica paper and glass/mica combination. The presence of polyester-polyol led to identical tan δ values.

1.-16. (canceled)

17. An insulation system comprising:
(a) a mica paper or mica tape containing one or more thermally activatable sulfonium salt initiators; and
(b) a thermally curable epoxy bath formulation comprising:
(i) a polyglycidyl ether, and
(ii) a cycloaliphatic epoxy resin comprising at least two epoxy groups, which are fused to a cycloaliphatic ring,
wherein the thermally curable epoxy bath formulation is substantially free of thermally activatable sulfonium salt initiators, and wherein the insulation system is substantially free of anhydrides.

18. The insulation system according to claim 17, wherein the one or more thermally activatable sulfonium salt initiators are present in the mica paper or mica tape in an amount from about 0.01 to about 10 g/m² of the mica paper or mica tape.

19. The insulation system according to claim 17, wherein the one or more thermally activatable sulfonium salt initiators are selected from the compounds of formula I to IV: 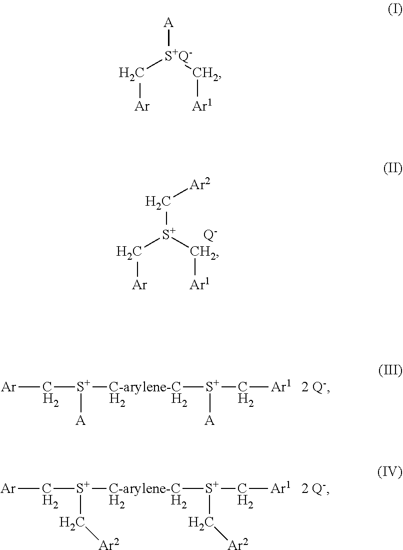
wherein:
A is C₁-C₁₂alkyl, C₃-C₈cycloalkyl, C₄-C₁₀cycloalkylalkyl or phenyl, which is unsubstituted or substituted by one or more substituents selected from C₁-C₈alkyl, C₁-C₄alkoxy, halogen, nitro, phenyl, phenoxy, C₁-C₄alkoxycarbonyl or C₁-C₁₂alkanoyl;
Ar, Ar¹ and Ar², independently of one another, are phenyl or naphthyl, which is unsubstituted or substituted by one or more substituents selected from C₁-C₈alkyl, C₁-C₄alkoxy, halogen, nitro, phenyl, phenoxy, C₁-C₄alkoxycarbonyl or C₁-C₁₂alkanoyl; and
Q⁻ is SbF₆⁻, AsF₆⁻ or SbF₅(OH)⁻.

20. The insulation system according to claim 17, wherein the polyglycidyl ether is a diglycidylether of phenolic compounds.

21. The insulation system of claim 20, wherein the polyglycidyl ether is a diglycidylether of phenolic compounds having the formula: 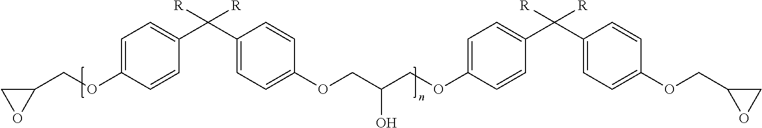
wherein the R groups are independently selected from hydrogen or methyl group and n is a number equal or greater than zero.

22. The insulation system according to claim 17, wherein the cycloaliphatic epoxy resin is selected from diepoxides of dicyclohexadiene or dicyclopentadiene, bis(2,3-epoxycyclopentyl) ether, 1,2-bis(2,3-epoxycyclopentyloxy)ethane, 3,4-epoxycyclohexyl-3′,4′-epoxycyclohexane-carboxylate, and 3,4-epoxycyclohexylmethyl-3′,4′-epoxycyclohexanecarboxylate.

23. The insulation system according to claim 17, wherein the thermally curable epoxy bath formulation comprises the polyglycidyl ether and the cycloaliphatic epoxy resin in a weight ratio between about 5:1 and about 1:10.

24. The insulation system according to claim 17, wherein the thermally curable epoxy bath formulation has a viscosity of not more than about 75 mPa·s at 60° C.

25. The insulation system according to claim 17, wherein the thermally curable epoxy bath formulation further comprises micro particles, nano particles or a mixture thereof and, optionally, a wetting agent.

26. A mica paper or a mica tape comprising one or more thermally activatable sulfonium salt initiators.

27. The mica paper or mica tape of claim 26, wherein the one or more thermally activatable sulfonium salt initiators is present in an amount of about 0.01 to about 10 g/m² of the mica paper or mica tape.

28. The mica paper or mica tape according to 26, wherein the one or more thermally activatable sulfonium salt initiators is dibenzyl-phenyl-sulfonium hexafluoroantimonate.

29. A method of manufacturing electrically insulated parts, comprising
(a) wrapping a part with a mica paper or mica tape containing one or more thermally activatable sulfonium salt initiators,
(b) contacting the part wrapped in mica paper or mica tape with a thermally curable epoxy bath formulation comprising (i) a polyglycidyl ether, and (ii) a cycloaliphatic epoxy resin comprising at least two epoxy groups, which are fused to a cycloaliphatic ring, wherein the thermally curable epoxy bath formulation is substantially free of thermally activatable sulfonium salt initiators,
(c) subjecting the part wrapped in mica paper or mica tape and the thermally curable epoxy bath formulation to a vacuum impregnation process such that the mica paper or mica tape is impregnated with at least a portion of the thermally curable epoxy bath formulation; and
(d) subjecting the part wrapped in mica paper or mica tape impregnated with at least a portion of the thermally curable epoxy bath formulation to heat sufficient to cure the thermally curable epoxy bath formulation.

30. The method of claim 29, wherein the part wrapped in mica paper or mica tape impregnated with at least a portion of the thermally curable epoxy bath formulation is heated in step (d) to a temperature between about 60° C. to about 200° C. for a time sufficient to cure the thermally curable epoxy bath formulation in the mica paper or mica tape.
